(19) United States
(12) Patent Application Publication
(10) Pub. No.: US 2024/0109221 A1
(43) Pub. Date: Apr. 4, 2024

(54) PROCESSING DEVICE AND METHOD FOR OPERATING A PROCESSING DEVICE

(71) Applicant: HOMAG GmbH, Schopfloch (DE)

(72) Inventors: Rolf HOFBAUER, Gäufelden (DE); Yimin GAN, Rottenburg am Neckar (DE)

(21) Appl. No.: 18/276,429

(22) PCT Filed: Feb. 9, 2022
(86) PCT No.: PCT/EP2022/053112

§ 371 Date: Aug. 8, 2023

(30) Foreign Application Priority Data
Feb. 10, 2021 (DE) 10 2021 103 106.0

(51) Int. Cl. B27C 9/02; G01B 11/16

(52) U.S. Cl. CPC B27C 9/02; G01B 11/16

(57) ABSTRACT

The invention relates to a processing device and a method for operating a processing device. Such a processing device is in particular a woodworking machine that is configured to process workpieces made of wood, wood materials or composite materials.

### TECHNICAL FIELD

The invention relates to a processing device and a method for operating a processing device. Such a processing device is in particular a woodworking machine that is configured to process workpieces made of wood, wood materials or composite materials. Such a woodworking machine is used in particular in the field of the furniture and components industry.

### PRIOR ART

Known in the prior art are devices with which process monitoring and control can be carried out during a processing procedure for coating a workpiece.

For example, EP 3 572 196 A1 shows a pressing device for pressing a coating material against plate-shaped or strip-shaped workpieces. This pressing device comprises a pressure roller as well as a holder that supports the pressure roller such that it can rotate about an axis. Further provided is a force regulating device that is configured to control, with or without feedback, a force with which the pressure roller is pressed against the coating material.

Even though such devices have proven effective, a constructional effort is required to integrate them into a processing device since the existing machine construction must be extended in order to integrate the corresponding sensor technology. The available installation space must hereby be utilised in such a way that the functionality and operational safety of the processing device are not adversely affected. This can be a major challenge owing to the wide variety of similar processing devices.

### DESCRIPTION OF THE INVENTION

An object of the invention is therefore to provide a processing device which, with few constructional modifications and/or little additional assembly effort, ensures improved process monitoring.

Such a processing device is described in claim 1. Further preferred embodiments are specified in the dependent claims. The invention furthermore provides a method for operating a processing device.

The invention is based on the realisation that on the basis of a measurement of an elastic deformation at components of a processing device, a conclusion can be drawn about forces acting during processing, and that on the basis of a detection during operation of the processing device, process monitoring and/or control of the processing procedure can take place. The components of the processing device evaluated by means of strain measurement do not have to be specifically modified. Such a component can rather be equipped with a sensor for detecting elastic deformation, for example a strain gauge sensor, in particular a strain gauge strip, a piezoelectric sensor, a capacitive sensor, an optical sensor or an inductive sensor, or can be evaluated by such a sensor without changing the dimensions and design of the component. The mechanical features of the corresponding component, such as strength and rigidity, thus remain the same or essentially the same.

A further calculation regarding load situations during operation, which would be necessary in the case of a modification of the structural components of the processing device, is not required. This approach furthermore also allows the retrofitting of processing devices since a specific, structurally similar or identical component only needs to be exchanged or supplemented with a strain gauge sensor.

According to the invention, a processing device is provided which comprises: a processing unit, a holder that supports the processing unit, a sensor for detecting deformation of the holder and a control device configured to control the position of the processing unit based on the measured values of the sensor.

By positioning the processing unit, the service life of the processing unit can be increased since an optimised use of the processing unit is ensured. By controlling the position of the processing unit, the processing quality can furthermore be improved.

It is preferred that the holder is movable by means of a drive, in particular a hydraulic cylinder, a pneumatic cylinder, a threaded rod or a linear drive. Control of the position of the processing unit can thus be carried out by the control device.

It is preferred that the sensor is applied to the holder. A measurement can thus be performed in the immediate vicinity of or at the holder.

It is preferred that the sensor is a strain gauge sensor, in particular a strain gauge strip, a piezoelectric sensor, a capacitive sensor, an optical sensor or an inductive sensor. Strains can thus be detected without changing the dimensions and design of the component.

According to a further embodiment, it is intended to provide a transmitter device for transmitting the measured values detected by the sensor to a central storage device, in particular a cloud. Based on the data transmitted to the central storage device, additional information can, for example, be generated for an operator. The control of the position of the processing unit that is ensured locally by the control device can thus be extended by further functions. The measured values stored in the central storage device can furthermore be used for machine learning.

According to a further object, a method is provided for operating a processing device, the processing device comprising a processing unit, a holder that supports the processing unit and a sensor for detecting deformation of the holder. The method comprises the steps of: detecting a deformation of the holder by means of the sensor and positioning the processing unit based on the measured values detected by the sensor.

By positioning the processing unit as part of the method, the service life of the processing unit can be increased since an optimised use of the processing unit is ensured. By controlling the position of the processing unit, the processing quality can furthermore be improved.

According to one embodiment, it is provided that the sensor is a strain gauge sensor, in particular a strain gauge strip, a piezoelectric sensor, a capacitive sensor, an optical sensor or an inductive sensor.

It is preferred that the measured values detected by the sensor are transmitted to a central storage device, in particular a cloud. Based on the data transmitted to the central storage device, additional information can, for example, be generated for an operator. The control of the position of the processing unit that is ensured locally by the control device can thus be extended by further functions. The measured values stored in the central storage device can furthermore be used for machine learning.

It may furthermore be provided that an operator is informed based on the measured values detected by the sensor. For example, actual deviations of the position of the processing unit from target values can be displayed to the operator.

### BRIEF DESCRIPTION OF THE DRAWINGS

Further features and advantages are apparent from the following description of embodiments with reference to the accompanying figures.

FIG. 1 is a schematic drawing of a first embodiment of a processing device according to the invention.

FIG. 2 shows a schematic representation of a second embodiment of a processing device according to the invention.

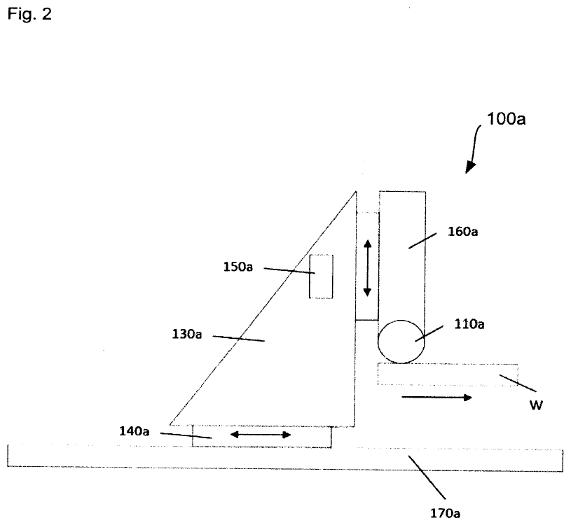

FIG. 3 shows a schematic representation of a third embodiment of a processing device according to the invention.

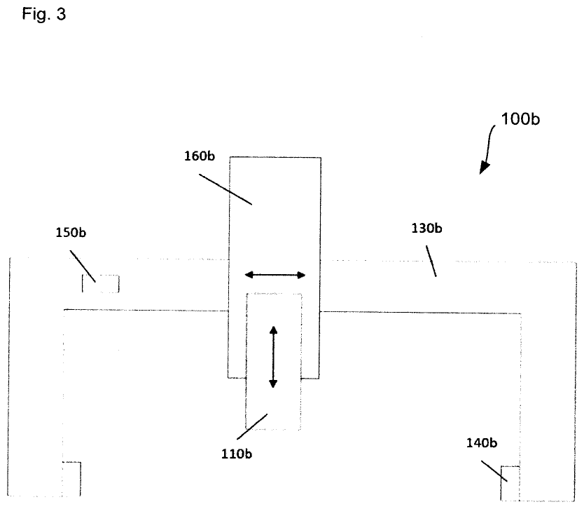

### DESCRIPTION OF EMBODIMENTS

Identical reference numbers that are used in different figures designate identical, corresponding or functionally similar elements.

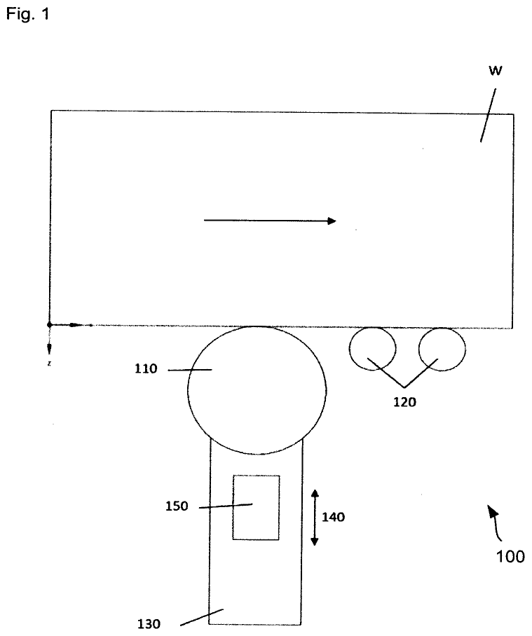

According to a first embodiment, a coating device 100 that is used to coat a narrow side of a plate-shaped workpiece is described as an example of a processing device. Such workpieces may be made, for example, from wood or wood materials. A schematic top view of the coating device 100 is shown in FIG. 1.

A strip-shaped coating material that may be provided with an activatable adhesive layer is in particular used for coating a workpiece W. Alternatively, the side of the workpiece W to be coated or the coating material is provided with an adhesive. A strip-shaped coating material, also referred to as an edge band, may be made of plastic, or it may be a veneer material, for example.

In the course of a coating process, the workpiece W is moved relative to the coating device 100 by a conveyor device (not shown). The workpiece W is thereby pressed against the conveyor device by means of a top pressure member and is thus held in a clamped state so that slipping of the workpiece W is prevented in this state.

The coating device 100 comprises a pressure roller 110 and a plurality of subsequent pressure rollers 120 that are attached to a movable holder 130. The holder 130 can be adjusted by means of a pneumatic cylinder 140 in order to move the pressure roller 110 and the subsequent pressure rollers 120 into a specific position in which the pressure roller 110 and the subsequent pressure rollers 120 are supposed to press a coating material onto a workpiece W. The position of the pressure roller 110 is determined relative to a stop (not shown) for guiding a workpiece W, namely depending on the thickness of the coating material to be applied to the narrow side of the workpiece W.

As a result of the pressure forces, mechanical stresses are transferred to the holder 130 during a coating process, which is elastically deformed due to the applied force.

Deformation can be detected by a strain gauge sensor 150 attached to a section of the holder 130. Since the dimensions and configuration of the holder 130 correspond to those of a holder without integration of the strain gauge sensor 150, the holder 130 can also be retrofitted as a retrofit part for an already existing coating device 100.

A contact force of the pressure roller 110 and the subsequent pressure rollers 120 can be quantitatively determined based on the measured values determined by the strain gauge sensor 150. The measured values can be used by a control device when controlling the pneumatic cylinder 140 (drive) such that a constant contact force is always provided. A high-quality coating result is thus guaranteed. Irregularities in the operation of the coating device 100 can also be detected at an early stage so that maintenance intervals can be planned accordingly.

The coating device 100 furthermore comprises a transmitter device for transmitting the measured values detected by the sensor 150 to a central storage device, in particular a cloud. The measured values can thus be centrally documented and further evaluated as required.

According to a second embodiment, a coating device 100a that is used in the field of stationary technology is described as a further example of a processing device. It is a so-called guided unit that is guided relative to a fixed workpiece in order to apply a coating material to a narrow side of such a workpiece in the course of the relative movement.

The coating device 100a comprises a pressure roller 110a mounted on a carriage 160a, the carriage 160a being supported by a holder 130a. The holder 130a can be moved relative to a beam-shaped support member 170a by means of a linear drive 140a.

A strain gauge sensor 150a is applied to the holder 130a, which is configured to detect a deformation of a section of the holder 130a. The measured values determined by the strain gauge sensor 150a can be received and processed by a control device of the coating device 100a.

In the course of a coating process, the carriage 160a is moved in a vertical direction relative to the holder 130a and the pressure roller 110a is thus positioned in a vertical direction. The holder 130a is furthermore moved relative to the beam-shaped support member 170a, which is movable relative to a machine bed, and the pressure roller 110a is thus guided along the workpiece to be coated.

A contact force of the pressure roller 110a can be quantitatively determined based on the measured values obtained by the strain gauge sensor 150a. The measured values can be used by the control device when controlling the linear drive to adjust the holder 130a such that a constant contact force is always provided.

According to a third embodiment, a CNC processing machine 100b comprising a beam-shaped holder 130b that is movable relative to a machine bed and to which an strain gauge sensor 150b is applied is presented as another example of a processing device.

A carriage 160b that accommodates a processing aggregate 110b (processing unit) is movably attached to the holder 130b. The processing aggregate 110b comprises a machining tool, for example a milling cutter. When processing a workpiece, the machining tool engages with the workpiece.

The holder 130b can be moved relative to a machine bed (not shown) by means of a linear drive 140b.

Due to dynamic and static forces during a processing procedure, which are caused by the engagement of the machining tool with the workpiece, the holder 130b can deform elastically. Owing to the deformation, the position of the tool centre point (TCP) deviates from the position calibrated in the idle state of the machine. The elastic deformation of the tool centre point TCP can be detected by the strain gauge sensor 150b so that the drives for moving the holder 130b can be controlled to compensate the changed tool centre point TCP. In this manner, the tool centre point TCP is readjusted such that it corresponds to the calibrated position.

Strain gauge sensors for detecting an elastic deformation of the holder are described in connection with the embodiments described above. In addition, the holder may be provided with one or more temperature sensors to validate the measurement results of the strain gauge sensors.

It is apparent to the person skilled in the art that individual features described in different embodiments can also be implemented in a single embodiment, provided that they are not structurally incompatible. Similarly, various features described in the context of a single embodiment may also be provided in several embodiments either individually or in any suitable sub-combination.

1. A processing device comprising:
a processing unit;
a holder that supports the processing unit;
a sensor for detecting a deformation of the holder; and
a control device configured to control the position of the processing unit based on the measured values of the sensor.

2. The processing device according to claim 1, wherein the processing unit comprises a pressure roller or a processing aggregate for machining.

3. The processing device according to claim 1, wherein the holder can be moved by a drive.

4. The processing device according to claim 1, wherein the sensor is applied to the holder.

5. The processing device according to claim 1, wherein the sensor comprises a strain gauge sensor, a piezoelectric sensor, a capacitive sensor, an optical sensor, or an inductive sensor.

6. The processing device according to claim 1, further comprising a transmitter device for transmitting the measured values detected by the sensor to a central storage device.

7. A method for operating a processing device, said processing device comprising a processing unit, a holder that supports the processing unit, and a sensor for detecting a deformation of the holder, said method comprising the steps of:
detecting a deformation of the holder by the sensor; and
positioning the processing unit based on the measured values detected by the sensor.

8. The method according to claim 7, wherein the sensor comprises a strain gauge sensor, a piezoelectric sensor, a capacitive sensor, an optical sensor, or an inductive sensor.

9. The method according to claim 7, wherein the measured values detected by the sensor are transmitted to a central storage device.

10. The method according to claim 7, wherein an operator is informed based on the measured values detected by the sensor.

11. The processing device according to claim 2, wherein the processing aggregate for machining comprises a milling unit, a drilling unit, or a sanding unit.

12. The processing device according to claim 3, wherein the drive is a hydraulic cylinder, a pneumatic cylinder, a linear drive, an electromechanical drive or a mechanical drive, namely a toothed rack or a threaded rod.

13. The processing device according to claim 6, wherein the central storage device comprise off-site cloud storage.
